(19) United States
(12) Patent Application Publication
(10) Pub. No.: US 2013/0028653 A1
(43) Pub. Date: Jan. 31, 2013

(54) CLAMPING APPARATUS FOR FASTENING A HOLLOW SHAFT OR HUB TO A SHAFT

(71) Applicant: GEORG BOEING, Rottenburg (DE)

(72) Inventor: GEORG BOEING, Rottenburg (DE)

(73) Assignee: Siemens Geared Motors Gesellschaft mit beschrankter Haftung, Tubingen (DE)

(21) Appl. No.: 13/361,522

(22) Filed: Jan. 30, 2012

(30) Foreign Application Priority Data
Jan. 31, 2011 (EP) EP 11152710

(51) Int. Cl. F16D 1/06

(52) U.S. Cl. 403/1

(57) ABSTRACT

A clamping device for fastening a member, such as a hollow shaft or hub, to a shaft includes a ring element which is provided with a cylindrical inner surface and has an end side which includes a plurality of axial threaded bores. The ring element is attached to one end of the member and axially fixed on the member by a support shoulder of the member and a securing ring fastened to the member. A clamping element has an end-side flange which is provided with a plurality of axial passage openings for receiving clamping screws. The clamping element has a portion provided with an outer taper and arranged radially between the shaft and an inner taper of the member, with the clamping element being threadably engaged to the ring element.

### CROSS-REFERENCES TO RELATED APPLICATIONS

This application claims the priority of European Patent Application, Serial No. EP11152710, filed Jan. 31, 2011, pursuant to 35 U.S.C. 119(a)-(d), the disclosure of which is incorporated herein by reference.

### BACKGROUND OF THE INVENTION

The present invention relates to a clamping apparatus for fastening a hollow shaft or hub to a shaft.

It would be desirable and advantageous to provide an improved clamping device for fastening a hollow shaft or hub to a shaft to obviate prior art shortcomings while yet being simple in structure and capable to provide increased radial forces in a press connection.

### SUMMARY OF THE INVENTION

According to one aspect of the present invention, a clamping apparatus for fastening a member, such as a hollow shaft or hub, to a shaft includes a ring element provided with a cylindrical inner surface and having an end side which includes a plurality of axial threaded bores, the ring element being attached to one end of the member and axially fixed on the member by a support shoulder of the member and a securing ring fastened to the member, and a clamping element having an end-side flange, the flange having a plurality of axial passage openings for receiving clamping screws, with the clamping element having a portion provided with an outer taper and arranged radially between the shaft and an inner taper of the member, the clamping element being threadably engaged to the ring element.

The ring element which can be pushed onto the hollow shaft or hub provides for an improved absorption of radial forces, because the ring element radially encompasses the hollow shaft or hub and the outer taper of the clamping element from the outside, and prevents the radial widening thereof, and at the same time enables centering. Assembly is simplified because the ring element already has threaded bores for connection to the clamping element, and as a result, the clamping element is reliably fixed via the ring element during assembly.

According to another advantageous feature of the present invention, the threaded bores and the passage openings can be arranged congruently.

According to another advantageous feature of the present invention, the threaded bores and the passage openings can be equidistantly distributed in a circumferential direction. This allows for a uniform distribution of radial forces which act on the hollow shaft or hub.

According to another advantageous feature of the present invention, the clamping screws can be inserted into the threaded bores through the passage openings, and the clamping element can be connected to the ring element by the clamping screws and can be braced axially against the ring element. This enables a simple assembly of the clamping apparatus.

According to another advantageous feature of the present invention, the ring element can have a substantially cylindrical outer surface and a substantially cylindrical inner surface. This enables particularly good absorption of radial forces. Advantageously, the ring element can be attached on the hollow shaft or hub with a predefinable or small clearance fit.

According to another advantageous feature of the present invention, the ring element and the portion of the clamping element can have substantially identical axial extents. The ring element and the clamping element can be made of cast iron, for example. This allows a cost-effective production of a clamping apparatus for fastening a hollow shaft or hub to a shaft. Advantageously, the ring element and the clamping element can be made of quenched and tempered or heat-treated, ductile nodular cast iron or of gray cast iron. Steels or forgings are of course also possible and permissible.

According to another advantageous feature of the present invention, a sleeve can be disposed on another end of the member, with the sleeve having a sleeve portion provided with an outer taper and arranged radially between the shaft and the member. The sleeve can have an end-side flange. An outer ring is disposed in radially surrounding relationship to the member for threaded engagement to the member, with the outer ring having an inner thread for connection to the flange of the sleeve, with an annular groove being formed between the outer ring and the sleeve portion. Because the outer ring is attached to the hollow shaft or hub by a threaded engagement, no additional components are required for axially fixing the sleeve.

According to another advantageous feature of the present invention, the flange of the sleeve can have a support shoulder which cooperates with a corresponding support shoulder of the outer ring for limiting an axial mobility of the outer ring. A securing ring can be fastened on the flange of the sleeve at an axial distance from the support shoulder of the sleeve, with the axial mobility of the outer ring in relation to the sleeve being limited by the support shoulder on the sleeve and by the securing ring.

According to another aspect of the present invention, a clamping device for fastening a member, such as a hollow shaft or hub, to a shaft includes a ring element having an end side which includes a plurality of axial threaded bores, the ring element having an inner thread for threaded engagement to an outer thread of the member, and a clamping element having an end-side flange, with the flange having a plurality of axial passage openings for receiving clamping screws, the clamping element having a portion provided with an outer taper and arranged radially between the shaft and an inner taper of the member, with the clamping element being threadably engaged to the ring element.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross-sectional illustration of one embodiment of a clamping apparatus according to the present invention at a first end of a hollow shaft;

FIG. 2 is a cross-sectional illustration of the clamping apparatus of FIG. 1 at a second end of the hollow shaft; and

FIG. 3 is a cross-sectional illustration of another embodiment of a clamping apparatus according to the present invention at a first end of a hollow shaft.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIG. 1, there is shown a cross-sectional illustration of a clamping apparatus according to the present invention for fastening one end of a hollow shaft 1 to a solid shaft 5. The hollow shaft 1 has an inner taper and an outer thread 6. A ring element 2, which is provided with an inner thread and has a plurality of axially extending threaded bores 9 at an end side, is screwed onto the outer thread 6. A clamping element 3 provided with an outer taper is arranged with a portion which is provided with the outer taper radially between the solid shaft 5 and the inner taper of the hollow shaft 1 and is screwed to the ring element 2. To this end, the clamping element 3 has a plurality of axially extending passage openings 10 for clamping screws 4 on an end-side flange. Here, corresponding threaded bores 9 and passage openings 10 are radially aligned and distributed in each case equidistantly in the circumferential direction. The clamping screws 4 are inserted into the threaded bores 9 through the passage openings 10. It is thereby possible for the clamping element 3 to be connected by means of the clamping screws 4 to the ring element 2 and to be clamped axially with respect to the latter.

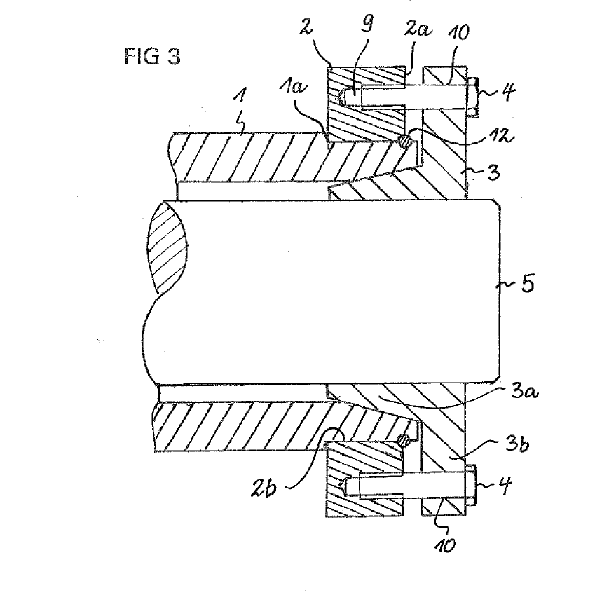

As an alternative to the configuration shown in FIG. 1, instead of an outer thread, the hollow shaft can be provided with a support shoulder for the ring element, which has a cylindrical inner surface instead of an inner thread. In this case, the ring element is fixed axially on the one hand by the support shoulder and on the other hand by a securing ring fastened to the hollow shaft. This embodiment is described further below in connection with FIG. 3.

The ring element 2 has a substantially cylindrical outer surface and a substantially cylindrical inner surface and is positioned on the hollow shaft 1 with a small clearance fit. Furthermore, the ring element 2 and the portion of the clamping element 3 which is provided with the outer taper have substantially identical axial extents. The ring element 2 and the clamping element 3 can be produced from cast iron, for example, in particular from quenched and tempered nodular cast iron, heat-treated, ductile nodular cast iron or gray cast iron. Steels or forgings can also be used, in principle.

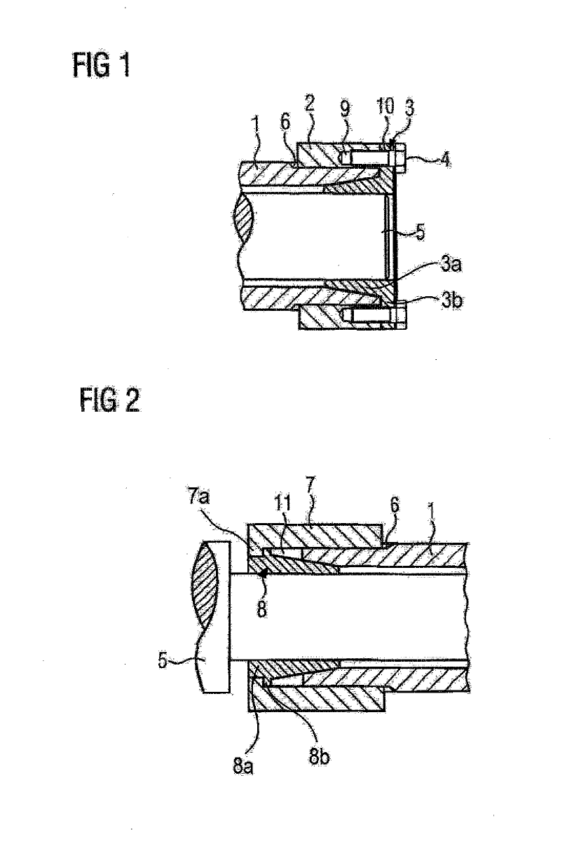

As shown in FIG. 2, the hollow shaft 1 can have an inner taper and an outer thread 6 at a second end. In addition, in this case the second end of the hollow shaft 1 is provided with a sleeve 8, which is provided with an outer taper and is arranged with a portion which is provided with the outer taper radially between the solid shaft 5 and the hollow shaft 1. The sleeve 8 has an end-side flange 8a to which an outer ring 7 which radially surrounds the hollow shaft 1 and has an inner thread is connected. The outer ring 7 is screwed onto the hollow shaft 1 at the second end. In this case, the sleeve 8 and the outer ring 7 can twist with respect to one another. As shown in FIG. 2, an annular groove 11 is formed between the outer ring 7 and the portion of the sleeve 8 which is provided with the outer taper.

A support shoulder 8b for the outer ring 7 is formed on the end-side flange on the sleeve 8, the axial mobility of which outer ring 7 is limited by the support shoulder 8b on the sleeve 8 and which outer ring 7 has a corresponding support shoulder 7a for the sleeve 8. In addition, the outer ring 7 can be fixed by a securing ring fastened on the end-side flange of the sleeve 8, and therefore the axial mobility of the outer ring 7 in relation to the sleeve 8 is limited on the one hand by the support shoulder on the sleeve 8 and on the other hand by the securing ring fastened to the sleeve 8. The securing ring is arranged at an axial distance from the support shoulder on the sleeve. The introduction of the securing ring achieves an axial connection between the outer ring 7 and the sleeve 8, and at the same time the two parts can be twisted in relation to one another.

Referring now to FIG. 3, there is shown a cross-sectional illustration of another embodiment of a clamping apparatus according to the present invention for fastening one end of a hollow shaft 1 to a solid shaft 5. Parts corresponding with those in FIG. 1 are denoted by identical reference numerals and not explained again. The description below will center on the differences between the embodiments. In this embodiment, provision is made for a ring element 2 provided with a cylindrical inner surface 2b. The ring element 2 has an end side 2a which includes a plurality of axial threaded bores 9. The ring element 2 is attached to one end of the hollow shaft 1 and axially fixed on the hollow shaft 1 by a support shoulder 1a of the hollow shaft 1 and a securing ring 12 fastened to the hollow shaft 1.

The clamping apparatus includes a clamping element 3 having an end-side flange 3b. The end-side flange 3b has a plurality of axial passage openings 10 for receiving clamping screws 4. The clamping element 3 has a portion 3a provided with an outer taper and arranged radially between the solid shaft 5 and an inner taper of the hollow shaft 1. The clamping element 3 is threadably engaged to the ring element 2.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A clamping device for fastening a member to a shaft, comprising:
a ring element provided with a cylindrical inner surface and having an end side which includes a plurality of axial threaded bores, said ring element being attached to one end of the member and axially fixed on the member by a support shoulder of the member and a securing ring fastened to the member; and
a clamping element having an end-side flange, said flange having a plurality of axial passage openings for receiving clamping screws, said clamping element having a portion provided with an outer taper and arranged radially between the shaft and an inner taper of the member, said clamping element being threadably engaged to the ring element.

2. The clamping apparatus of claim 1, wherein the member is a hollow shaft or hub.

3. The clamping apparatus of claim 1, wherein the threaded bores and the passage openings are arranged congruently.

4. The clamping apparatus of claim 3, wherein the threaded bores and the passage openings are equidistantly distributed in a circumferential direction.

5. The clamping apparatus of claim 1, wherein the clamping screws are inserted into the threaded bores through the passage openings, said clamping element being connected to the ring element by the clamping screws and braceable axially against the ring element.

6. The clamping apparatus of claim 1, wherein the ring element has a substantially cylindrical outer surface.

7. The clamping apparatus of claim 1, wherein the ring element is attached to the member with a predefinable clearance fit.

8. The clamping apparatus of claim 1, wherein the ring element and the portion of the clamping element have substantially identical axial extents.

9. The clamping apparatus of claim 1, wherein the ring element and the clamping element are made of cast iron.

10. The clamping apparatus of claim 1, wherein the ring element and the clamping element are made of nodular cast iron.

11. The clamping apparatus of claim 1, wherein the ring element and the clamping element are made of quenched and tempered nodular cast iron.

12. The clamping apparatus of claim 1, wherein the ring element and the clamping element are made of heat-treated, ductile nodular cast iron.

13. The clamping apparatus of claim 1, wherein the ring element and the clamping element are made of gray cast iron.

14. The clamping apparatus of claim 1, wherein the ring element and the clamping element are made of steel.

15. The clamping apparatus of claim 1, further comprising a sleeve disposed on another end of the member, said sleeve having a sleeve portion provided with an outer taper and arranged radially between the shaft and the member, said sleeve having an end-side flange, and further comprising an outer ring disposed in radially surrounding relationship to the member for threaded engagement to the member, said outer ring having an inner thread for connection to the flange of the sleeve, with an annular groove being formed between the outer ring and the sleeve portion.

16. The clamping apparatus of claim 15, wherein the flange of the sleeve has a support shoulder cooperating with a corresponding support shoulder of the outer ring for limiting an axial mobility of the outer ring.

17. The clamping apparatus of claim 16, further comprising a securing ring fastened on the flange of the sleeve at an axial distance from the support shoulder of the sleeve, with the axial mobility of the outer ring in relation to the sleeve being limited by the support shoulder on the sleeve and by the securing ring.

18. A clamping device for fastening a member to a shaft, comprising:
a ring element having an end side which includes a plurality of axial threaded bores, said ring element having an inner thread for threaded engagement to an outer thread of the member; and
a clamping element having an end-side flange, said flange having a plurality of axial passage openings for receiving clamping screws, said clamping element having a portion provided with an outer taper and arranged radially between the shaft and an inner taper of the member, said clamping element being threadably engaged to the ring element.
